(19) United States
(12) Patent Application Publication
(10) Pub. No.: US 2011/0259274 A1
(43) Pub. Date: Oct. 27, 2011

(54) Cat litter box

(76) Inventor: Christina A. Rinearson, Colleyville, TX (US)

(21) Appl. No.: 12/799,257

(22) Filed: Apr. 21, 2010

(51) Int. Cl. A01K 29/00

(52) U.S. Cl. 119/165

(57) ABSTRACT

A stainless steel litter box is provided in which three of the walls extend upward perpendicular to a base, and one of the four wall extends upward at an obtuse angle and the walls are at least about 6 inches high.

### BACKGROUND OF THE INVENTION

1. Field of the Invention

This invention relates to boxes used to contain cat litter.

2. Description of the Related Art

Containers generally made of plastic, containing cat litter and known generally as litter boxes, are used for cats (and sometimes dogs) that are kept indoors. The granular cat litter is typically formulated to become hard when it absorbs a liquid such as urine. When a cat enters to the container and excretes urine or feces on the litter, the owner can remove the feces and soiled litter, and add new replacement litter.

Litter boxes are made in a great variety of sizes and designs. While traditionally such containers are flat-bottomed, four-sided containers, many more elegant versions have been developed, for example, containers with covers, additional walls, gratings, and various automatic cleaning devices. Some of these boxes are so elaborate or noisy that they are frightening to the cat or difficult for the cat to use. As their complexity increases, these complex litter boxes often are of increased size and take up more room in the owner's home.

The basic need, however, is to have a container into which the pet can be trained to relieve itself. Preferably, this litter box can be located at a place in the home that is accessible to the cat but does not present a visual, space or olfactory problem for the home-dwellers.

For many cat owners, the most desirable place to put a litter box is in the bathroom between the toilet and wall (or bathroom divider or cabinet). In most homes, this is a very narrow space with a shape partly defined by the bulging base of the toilet. Most litter boxes, even the most simple ones, do not fit in this small defined space, unless there are sized specifically for kittens. Even a small rectangular litter box typically has vertical walls that do not fit in the space between the toilet base and the wall. Reducing the height of the walls of the litter box may make it fit better in the small space, at least if the dimensions of the base of the box are small enough. Reduced wall height, however, means that that less litter can be contained in the box, and increases the likelihood that cat movements will cause litter or fecal material to be pushed over the wall, and/or that the cat will not be completely within the box when relieving itself.

While plastic litter boxes may in some cases be sufficiently flexible so that the box can be bent to squeeze it to fit into the space between the toilet and the wall, plastic litter boxes become stained and scratched so that bacteria and debris can linger in the scratched areas, and prevent complete cleaning of the box. In addition, the plastic used in the litter boxes can sag or become misaligned through constant use, particularly if the box must routinely be bent to fit it into the bathroom site.

It is therefore an object of the invention to provide a cat litter box that fits within the space formed by the base of a toilet and the bathroom wall (or divider) and has high enough sides to keep litter and fecal material in the box.

Other objects and advantages will be more fully apparent from the following disclosure and appended claims.

### SUMMARY OF THE INVENTION

The invention herein is a cat litter box having a rectangular base surrounded by upwardly extending walls on all sides of the rectangular base. There are three vertical walls extending upward at a 90-degree angle from the base. The fourth wall extends upward at an obtuse angle from the base, preferably at an angle of about 105 degrees.

Other objects and features of the inventions will be more fully apparent from the following disclosure and appended claims.

### BRIEF DESCRIPTION OF THE DRAWINGS

FIG. 1 is a side perspective view of the cat litter box of the invention herein.

FIG. 2 is an elevational view of one of the parallel sides of the cat litter box of FIG. 1.

FIG. 3 is a top plan view of the litter box of the invention.

FIG. 4 is a partial side perspective view of the cat litter box of the invention with an upper rim.

### DETAILED DESCRIPTION OF THE INVENTION AND PREFERRED EMBODIMENTS THEREOF

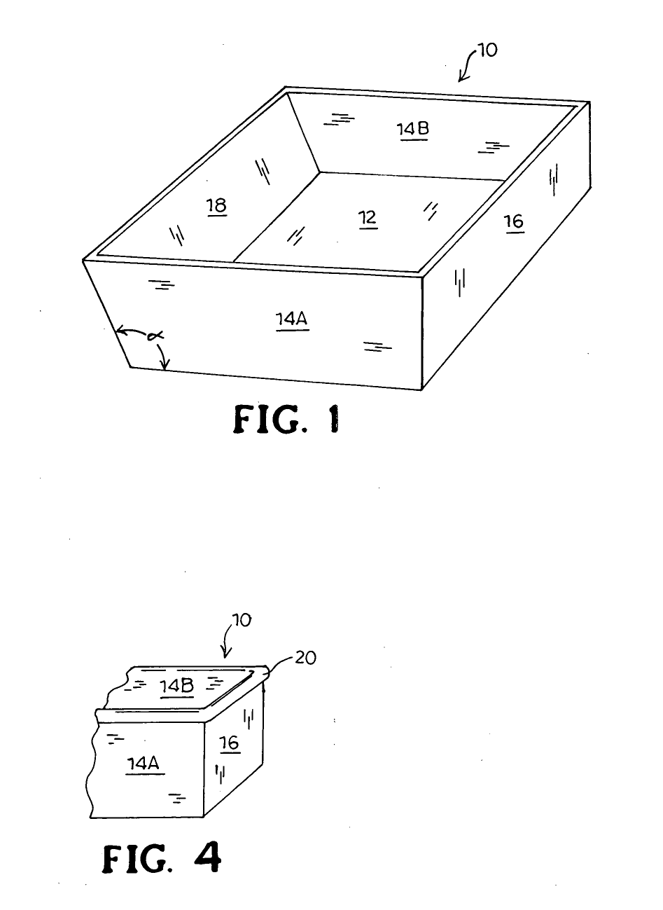

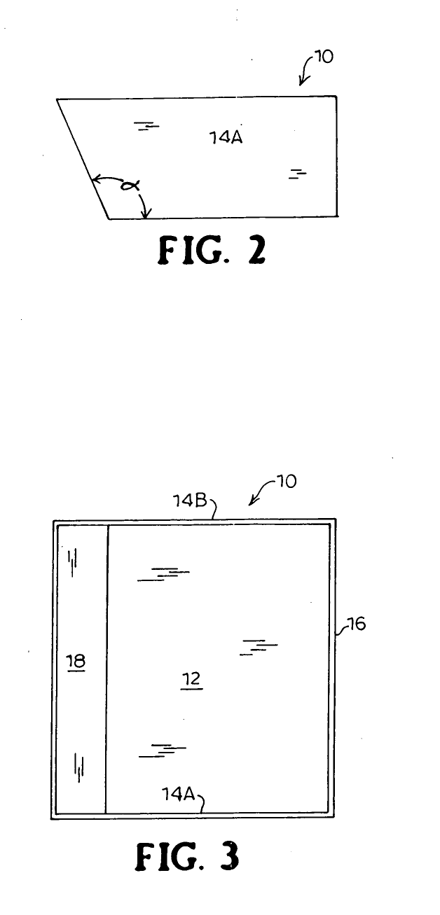

The present invention is a cat litter box 10 as shown in FIG. 1, having a rectangular base 12 surrounded by upwardly extending walls on all sides of the rectangular base 12. The rectangular base 12 preferably has dimensions of about 9 to about 12 inches by about 15 to about 20 inches, and most preferably the base is about 11.5×15.0 inches in size.

There are three vertical walls 14A, 14B, 16 extending upward at a 90-degree angle from the rectangular base 12. The preferred height of these three walls is about 3 to about 9 inches, and most preferably the height is 6 inches.

The fourth wall 18 extends upward at an obtuse angle, α, from the rectangular base 12. Preferably the obtuse angle α is an angle from greater than 90 degrees to 120 degrees, and most preferably the obtuse angle α is an angle of about 105 degrees. The fourth wall 18 has its top edge level with that of the other three walls, and therefore when the other three walls are 6 inches high, the fourth (angled) wall has an upward length of 6.25 inches. Because of the fourth wall 18 being angled as disclosed herein, the opening at the top of the box is preferably about 14×15 inches as shown in FIG. 1, as compared with the lower box dimensions of about 11.5×15 inches. Thus, the two parallel vertical walls 14A, 14B have a lower length of about 11.5 inches and an upper length of about 14 inches in the preferred embodiment herein and the perpendicular vertical wall 16 and the fourth wall 18 are each rectangles with an upper and lower length of 15 inches in the preferred embodiment.

Optionally, the cat litter box 10 of the invention may have an upper rim 20 as known in the art, one possibility being shown in FIG. 4.

The litter box 10 of the invention is most preferably completely made of stainless steel of a sufficient weight as known in the art of making pans and the like so that it can be filled with litter and placed into position without becoming bent or malformed.

As with litter boxes known in the art, the litter box of the invention is filled with the owner's chosen litter product for use by a cat (or other animal), allowed to remain in place, with the litter being cleaned as desired and needed, with periodic emptying and cleaning of the litter box as known in the art. Because the litter box is made of stainless steel, however, cleaning the box is much more simple and sanitary than with prior plastic litter boxes.

While the invention has been described with reference to specific embodiments, it will be appreciated that numerous variations, modifications, and embodiments are possible, and accordingly, all such variations, modifications, and embodiments are to be regarded as being within the spirit and scope of the invention.

What is claimed is:

1. A cat litter box, comprising: a rectangular base surrounded by upwardly extending walls on all sides, the walls comprising three vertical walls extending upward at a 90-degree angle from the base and a fourth wall extending upward at an obtuse angle from the base, and the base and walls being made of stainless steel.

2. The cat litter box of claim 1, wherein the obtuse angle is an angle from over 90 degrees to 120 degrees.

3. The cat litter box of claim 2, wherein the obtuse angle is an angle of about 105 degrees.

4. The cat litter box of claim 1, wherein the three vertical walls are 3 to 9 inches high.

5. The cat litter box of claim 4, wherein the three vertical walls are 6 inches high.

6. The cat litter box of claim 1, wherein the rectangular base is about 11.5×15.0 inches in size.

7. The cat litter box of claim 1, further comprising an upper rim around the walls.
